(19) United States
(12) Patent Application Publication
(10) Pub. No.: US 2023/0382145 A1
(43) Pub. Date: Nov. 30, 2023

(54) PRODUCTION SYSTEM, PROCESS AND MODULAR FRAGRANCE UNIT FOR PROCESSING AND/OR FINISHING A PRINT SUBSTRATE

(71) Applicant: Andreas LUETTICH, Rauenberg (DE)

(72) Inventor: Andreas LUETTICH, Rauenberg (DE)

(21) Appl. No.: 18/265,746

(22) PCT Filed: Nov. 3, 2021
(86) PCT No.: PCT/DE2021/200172

§ 371 Date: Jun. 7, 2023

(30) Foreign Application Priority Data
Dec. 8, 2020 (DE) 10 2020 215 484.8

(51) Int. Cl. B41M 3/00; B41F 19/00

(52) U.S. Cl. CPC B41M 3/006; B41F 19/002

(57) ABSTRACT

A modular production system for processing and/or finishing a print substrate, with a plurality of modular units, is characterized in that the modular units comprise a modular fragrance unit, which is designed to apply a fragrance to the print substrate. Furthermore, a method is disclosed for processing and/or finishing a print substrate. Finally, a modular fragrance unit for processing and/or finishing a print substrate is disclosed.

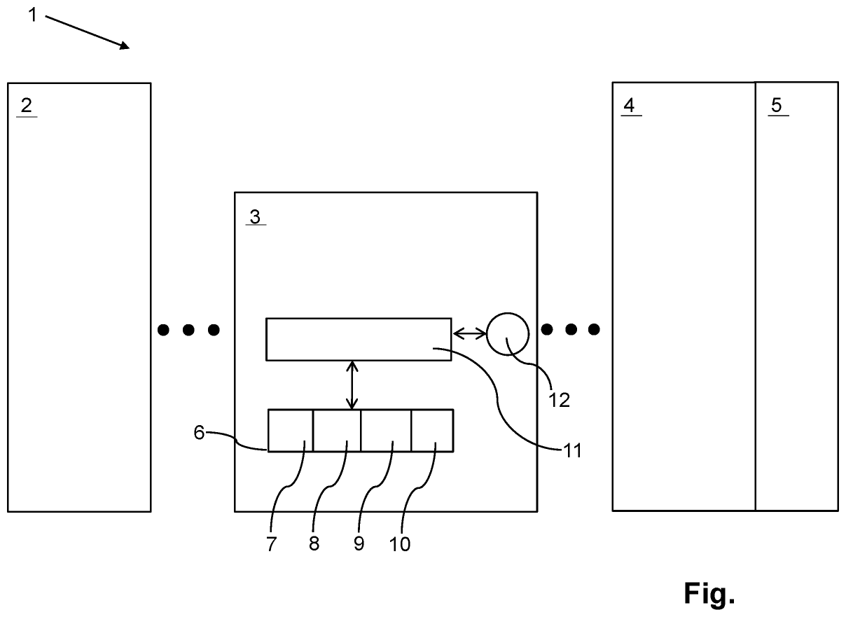

The invention relates to a modular production system for processing and/or finishing a print substrate, comprising a plurality of modular units.

Furthermore, the invention relates to a method for processing and/or finishing a print substrate.

Finally, the invention relates to a modular fragrance unit for processing and/or finishing a print substrate.

Production printing systems and methods of the type in question for processing and/or finishing a print substrate have been known from practice for years. Thus, within the framework of print processing and finishing there are diverse techniques and options for providing an appealing, high-quality printed product tailored for the respective target group. Print finishing may comprise a change in the surface of a printed product, which can take place inline (in the printing press) or in a subsequent process. Different effects of finishing can change the structure, the optical and tactile effect of the material. Print finishing may offer different possibilities for customization, wherein the paper as print substrate may for instance be coated by different methods. Hence, the printed products may be upgraded by print finishing and the resulting advertising materials then appear to be of higher quality.

In practice, on a regular basis there is a need to create personalized printed products, whereby a differentiation may be achieved by high quality and innovation in the market vis-à-vis competitors.

In addition to various types and options of print finishing, according to which special effects may be produced or generated, for instance, by means of special coatings (dispersion coating, UV coating, relief coating, etc.) or special embossings (blind embossing, relief embossing, steel engraving, etc.), it is also known from practice to provide the printed product with a fragrance.

In particular it is important for communication that images remain in memory for a longer period of time when they are perceived coupled with fragrances. Fragrance significantly increases memory performance. A multi-sensual appeal can for instance significantly increase a spontaneous purchasing rate of scented product packages. In addition, specific feelings are simultaneously conveyed. Thus, a marketing message with fragrance arouses emotions and curiosity, and therefore the perception of the target audience of the advertisement.

For instance, scented papers are known from practice that can be used as a sales tool. Scented pigments are integrated in a special paper by means of special, sophisticated coating processes to produce the scented papers, so that the aroma can also be sustained. When the fragrance comes into contact with the air, it can automatically unfold. The production of such scented papers is however time-consuming and expensive, so that using correspondingly designed printed products proves to be disadvantageous.

Furthermore, print finishing of printed products with scented coatings is known from practice. A scented coating is defined as a special effect coating, which is provided with microcapsulated aromatic substances and applied as the last coating to the printed product. The included aromatic substances or essential oils are thus directly applied with the coating to be printed on the printed product. By means of the exertion of pressure, friction, or opening a print substrate provided with this scented coating, these capsules burst open and release a fragrance. However, the disadvantage to using scented coating is that the respective scented coatings are expensive. A further problem is that during a subsequent finishing process, pressure or scuffing on the already finished product can hardly be avoided or cannot be avoided. As a result, the microcapsules contained in the coating are destroyed. When a print substrate is fed or transported or folded, stapled, put in an envelope, the mechanical load of the print substrate is sufficient to destroy the microcapsules contained in the coating. Moreover, a coating that has already been printed on should not be printed again. Thus, it is also no longer possible to print the reverse side, since otherwise the capsules of the front side would break open.

Therefore, the present invention addresses the problem of developing and improving a modular production system and a method of the initially mentioned type for processing and/or finishing a print substrate such that with simple design means the most efficient and/or flexible scented finishing of the print substrate is made possible, in particular with respect to a most efficient and flexible processing process chain by means of the production system.

In accordance with the invention, the above problem is solved by the features of claim 1. Accordingly, the modular production systems in question for processing and/or finishing a print substrate with a plurality of modular units, is characterized in that the modular units comprise a modular fragrance unit, which is designed to apply a fragrance to the print substrate.

The above problem is furthermore solved by a method with the features of claim 11. According to this claim, the method for processing and/or finishing a print substrate is characterized in that, after the print substrate has been printed by means of a modular printing unit, a fragrance is applied to the print substrate using a modular fragrance unit.

Finally, the previous problem is solved by a modular fragrance unit with the features of claim 16. According to this claim, a modular fragrance unit is specified, which comprises means for applying a fragrance to the print substrate.

In a manner in accordance with the invention, it has been recognized that it is a considerable advantage when, with respect to a scenting of the print substrate (i.e., providing the print substrate with a fragrance), the scenting process (i.e., the process of applying the fragrance to the print substrate) is carried out by means of a modular unit that has been separately provided or designed for this purpose. Accordingly, the print substrate is not provided with a fragrance within the scope of the concrete printing process, during which text and/or image content is printed on the print substrate, but rather is provided within the scope of its own, separate scenting process by the modular fragrance unit. This supplies considerably more flexibility and efficiency with respect to the operation of the production system, in particular with regard to the processing process chain to be carried out by the production system. The scenting process can thus occur independently and detached from printing process. For example, the print substrate can be provided only with a fragrance using the modular fragrance unit within the scope of a scenting process, namely such that neither optical nor haptic effects are formed on the print substrate, as would be the case when using a scented coating.

Since the fragrance may be applied to the print substrate in liquid and/or gaseous form, in particular as an aerosol, a print substrate with a fragrance is produced, in which the scent is virtually “invisible”. Rubbing is not necessary. Instead, a print substrate may be created for which neither adverse optical nor haptic effects arise, as is the case for instance with a scented coating. A variety of fragrances are conceivable using aromatic substances or essential oils, which could be used for scenting the print substrate.

In this context it must be pointed out that a print substrate can be any printed product. The print substrate (printed stock or substrate) may also be a component of a printed product, which is produced by the printing process chain of the modular production system. In the simplest case, it could be paper, which is delivered as print substrate via the individual modular units of the production system. Thus, the print substrate may be a material which can be printed in various printing processes, thus a material, which may be printed using known technical methods. Examples could be paper, cardboard, foil, sheet metal and/or textiles (photo canvas) etc.

Furthermore, it should be noted that a production system—in particular within the scope of the claims and preferably within the scope of the description—is to be understood as a system for processing and/or finishing a print substrate or a substrate in the broadest sense. Preferably, a production system is to be understood as a production printing system, wherein along with a printing of a print substrate further processing steps may also occur. In the process, a variety of printing technologies for the production printing system come into consideration. For example, digital printing is conceivable, possibly in office environments etc.

A modular fragrance unit according to one exemplary embodiment of the invention can also be used within the scope of offline- or nearline methods and/or postpress systems as a postprocess processing system or production system or integrated there. For instance, brochure, hot glue, stapling, folding, coating and/or inserting systems or finishers are conceivable.

In advantageous manner, the modular fragrance unit may be designed as a separate modular unit. In so doing, it is conceivable that the modular fragrance unit is used as an independent modular unit within the scope of an offline processing/finishing or in the offline process (also called the nearline process). Thus, the modular fragrance unit may be used as an isolated processing station for finishing the print substrate.

Furthermore, it is conceivable that the modular fragrance unit is used as a separate modular unit within the scope of an inline processing/finishing or in the inline process. In inline processing, the process of scenting the print substrate by the modular fragrance unit takes place directly in the printing press or in the production system. I.e., the modular fragrance unit be can permanently linked or coupled to the printing press as a separate modular unit, however in the process forming where applicable its own modular unit as a separate, possibly interchangeable component of the entire processing process chain of the modular production system. Hence, the modular fragrance unit may be arranged within the scope of a processing process chain of modular units for printing, coating, folding, stapling and/or for quality control etc. The modular integration of the modular fragrance unit in the modular production system makes for a flexible and variable installation and uninstallation of the modular fragrance unit in the production system.

In one advantageous embodiment, the modular fragrance unit—within the scope of the processing process chain of the production system—may be arranged downstream of a modular printing unit for printing the print substrate. Hence, the scenting process of the print substrate by the modular fragrance unit can be downstream of the printing process which is carried out by a corresponding modular printing unit. Within the scope of the processing process chain, the print substrate can be conducted or conveyed via the individual modular units of the production system and hence be processed or finished sequentially, in order to then provide a finished, high-quality and, where applicable, individualized printed product.

In a further advantageous embodiment, the modular fragrance unit may be designed such that it is used as a rewetting unit for the print substrate. By means of this sophisticated combination, both a rewetting and a scenting of the print substrate may be implemented in one modular unit. In the process, the fragrance can be expediently applied to the print substrate in liquid form and/or as an aerosol. In various printing processes a drying of the inks occurs, which can lead to considerable problems in the subsequent processing. By having the modular fragrance unit carry out a rewetting and thus act as a rewetting unit, the water content after drying in the paper or in the print substrate can be increased to the necessary value again. In advantageous manner, the front and reverse side of the print substrate or of the printing paper can be moistened, in order to smooth the print substrate. Both sides of the print substrate may be expediently uniformly moistened. The special advantage lies in the improved anti-frictional properties of the remoistened print substrate/papers. Fewer web breaks and higher speeds result, both during printing of the print substrate as well as in the subsequent further processing processes within the scope of the print production system. As a result, a more efficient procedure is made possible.

The following advantages are for instance possible by means of a, preferably electrostatic, remoistening or rewetting of the print substrate:
significantly lower formation of waves during adhesive binding
no fiber breakage in the fold
no hygroexpansivity of the trimmed products
no climate waves

Thus, the performance of the production system can be enhanced by rewetting the paper with the modular fragrance unit. Specifically, by rewetting the paper, the occurrence of waviness and plates in the print substrate (for instance also in a printed sheet) can be effectively prevented.

Regarding a scenting of the print substrate with simple design means, the modular fragrance unit can have at least one contact roller. The contact roller is designed such and arranged in the modular fragrance unit such that the fragrance is applied to the print substrate via the contact roller. The fragrance may be expediently present in liquid form. The contact roller is wetted with the liquid fragrance and is then used to apply the fragrance to the print substrate. In the process, the contact rollers can be expediently arranged such that the print substrate is delivered across the contact rollers. Moreover, it is conceivable that the print substrate for instance is conveyed or moved by two opposing contact rollers and in the process the liquid fragrance is applied to the print substrate, bilaterally or unilaterally. Hence, a simple and efficient application of the printing matter on the print substrate may be realized.

In advantageous manner, the modular fragrance unit may have at least one wetting roller. The wetting roller is designed to wet a contact roller with the preferably liquid fragrance. Depending on the number of contact rollers that are used, it is conceivable that at least one wetting roller is respectively provided for each contact roller, to wet or supply the contact rollers with the liquid fragrance.

In one advantageous embodiment, the modular fragrance unit can comprise a liquid bath, which provides the fragrance in liquid form. In the process, it is for instance conceivable that the print substrate is brought directly into contact with the liquid bath, in order in this way to apply the fragrance to the print substrate. Furthermore, it is conceivable that application means of the modular fragrance unit are in contact with the liquid bath, in order to supply the application means with the fragrance, wherein the application means can then in turn directly or indirectly supply the print substrate with the fragrance. Thus, it would also be conceivable that a wetting roller absorbs the fragrance via the liquid bath and then wets the contact roller with the fragrance, so that then in turn the contact roller can apply the fragrance to the print substrate. In any event, the fragrance in the modular fragrance unit can be provided via the liquid bath, which for instance is designed as a liquid container.

Within the scope of one advantageous embodiment, the modular fragrance unit can comprise a spraying device, wherein the spraying device is designed to spray the print substrate with the fragrance or to mist the print substrate with the fragrance. Hence, a simple and efficient application of the fragrance to the print substrate is possible.

Regarding the availability of the fragrance, the modular fragrance unit can comprise a tank device for storing the fragrance. In advantageous manner, the tank device can comprise a magazine of a plurality of tank containers. Hence, a plurality and a variety of fragrances may be supplied by the tank device and be provided as needed for the scenting of the print substrate. The fragrance can preferably be stored in the tank device in liquid form. It is conceivable that the application means supplies the modular fragrance unit with the fragrance via the tank device. Moreover, it is conceivable that the tank device is used to supply or fill the liquid bath as needed with the fragrance. In particular, in the case of a variant with a tank device, which comprises a magazine of a plurality of tank containers, it is possible in sophisticated manner, if necessary, to fill the liquid bath with the respective desired fragrance and/or to directly or indirectly supply the application means of the modular fragrance unit with the respective desired fragrance.

In one advantageous embodiment, the modular fragrance unit may comprise a cleaning device. The cleaning device can for instance carry out a pumping out and/or rinsing and/or filling of the liquid bath or of a container, which is used to provide a fragrance. Hence, the modular fragrance unit can if necessary be filled and operated with different fragrances. In any event, a simple change of different fragrances is possible for the modular fragrance unit. This may also comprise a recycling of the fragrance in the tank device for further storage.

In one advantageous embodiment, the fragrance can be applied to the print substrate by the modular fragrance unit by means of a print head. This could be realized for instance with a print head according to inkjet printing technology. Hence, an efficient embodiment of an application means for the modular fragrance unit is provided.

In one advantageous embodiment, it is conceivable that the fragrance is mixed into a preferably odor-free ink. The ink, including the fragrance, can then be printed on the print substrate. Hence, a most efficient possible application of the fragrance to the print substrate is realized.

In one advantageous embodiment, the modular fragrance unit may comprise a separate printing unit. For instance, this could be a printing unit in accordance with offset printing technology. The printing unit uses a moistening agent during operation, wherein the fragrance is mixed into the moistening agent in a sophisticated manner. Thus, it is conceivable that a separate printing unit runs in offset, that then runs virtually at “idle” in place of the usual moistening agent or the usual aqueous solution with the liquid fragrance. Hence, an efficient embodiment of an application means for the modular fragrance unit is provided.

In one advantageous embodiment, the preferably liquid fragrance is applied to the print substrate by means of silk screen printing.

There are various possibilities for advantageously embodying and further developing the teaching of the present invention. To this end, on the one hand, reference is made to the claims depending from claims 1 and 11 and on the other hand, reference is made to the following explanation of preferred exemplary embodiments of the invention based on the drawings. In conjunction with the explanation of the preferred exemplary embodiments of the invention based on the drawings, preferred embodiments and further developments of the teaching in general will also be explained. In the drawing, the only FIGURE

FIG. shows a schematic view of a modular production printing system as a production system according to one exemplary embodiment of the invention.

The only FIGURE shows a modular production printing system 1 comprised of a plurality of modular units for processing and/or finishing a print substrate. The print substrate can be any printed product and/or a component of a printed product, which is produced by the processing process chain of the production printing system 1 or is finished by processing/finishing. In the simplest case, it could be paper, which is transported as print substrate via the individual modular units of the production printing system 1. Depending on the modular unit, the print substrate undergoes a corresponding processing or finishing.

The production printing system 1 comprises a modular printing unit 2, a modular fragrance unit 3, a modular folding and hole punching unit 4, and a modular stapling unit 5. The modular printing unit is used to print the print substrate with text or image content. This may also comprise the application of various coatings to the print substrate. Further modular units can be coupled to the production system 1 or—if necessary—also be exchanged or completely removed.

Due to the modular embodiment of the production printing system, further and/or alternative modular units are also conceivable, for instance a brochure finisher and the like. Also, the arrangement of the modular fragrance unit 2 in accordance with the invention within the scope of the production printing system 1 can vary. In particular, by virtue of the installation as a separate modular fragrance unit, it can be arranged—in principle—anywhere in the processing process chain.

The modular fragrance unit 2 is used to apply a fragrance to the print substrate. In the process, the modular fragrance unit 2 has a tank device 6 with a plurality of tank containers 7, 8, 9 and 10, in order to store a plurality of different fragrances. The fragrance is applied to the print substrate via application means 11. The application means 11 can comprise various rollers and/or a liquid bath, which is/are designed to provide the print substrate with the fragrance. Moreover, a spraying device as application means 11 is also conceivable.

Since the fragrance is applied to the print substrate in liquid and/or gaseous form, in particular as an aerosol, a print substrate is produced with a fragrance in which the scent is virtually “invisible”. Rubbing is not necessary, as is the case with an applied scented coating, which contains microcapsulated aromatic substances.

The tank device 6 is used to supply the application means 11. Furthermore, the modular fragrance unit 3 comprises a cleaning device 12. The cleaning device 12 is used to clean the application means 11, so that the fragrance—depending on the application—can be changed. Hence, the modular fragrance unit 3 may, if necessary, be filled and operated with different fragrances. A simple changing of the fragrances for the modular fragrance unit 3 is guaranteed.

After the print substrate has been provided with a fragrance, the print substrate provided with a fragrance (scented) may be transported within the scope of the print production system 1 to further modular units and further processed or finished there. However, it is also conceivable that the modular fragrance unit 3 is arranged elsewhere, for example at the last point of the processing process chain. It is advantageous when the process of scenting takes place after the actual printing process of the modular printing unit 2. However, due to the modular implementation it is also possible to arrange the modular fragrance unit 3 upstream of the modular printing unit 2.

Regarding further advantageous embodiments of the production system in accordance with the invention and of the method in accordance with the invention, to avoid repetition, reference is made to the general part of the description and the attached claims.

Finally, express reference is made to the fact that the previously described exemplary embodiments of the device in accordance with the invention serve only the purpose of discussing the claimed teaching, but do not limit said teaching to the exemplary embodiments.

### LIST OF REFERENCES

1 production printing system
2 modular printing unit
3 modular fragrance unit
4 modular folding and hole
   punching unit
5 modular stapling unit
6 tank device
7 tank container
8 tank container
9 tank container
10 tank container
11 application means
12 cleaning device

1-16. (canceled)

17. A modular production system, in particular a modular production printing system, for processing and/or finishing a print substrate, comprising a plurality of modular units, characterized in that the modular units comprise a modular fragrance unit, which is designed to apply a fragrance to the print substrate, and wherein the modular fragrance unit comprises a tank device for storing the fragrance.

18. The production system according to claim 17, characterized in that the modular fragrance unit is designed as a separate modular unit.

19. The production system according to claim 17, characterized in that the modular fragrance unit is arranged downstream of a modular printing unit for printing the print substrate.

20. The production system according to claim 17, characterized in that the modular fragrance unit is designed such that it is used as a rewetting unit for the print substrate.

21. The production system according to claim 17, characterized in that the modular fragrance unit has at least one contact roller, which is designed to apply the fragrance to the print substrate, wherein the modular fragrance unit can comprise one or a plurality of wetting rollers, which is/are designed to wet the at least one contact roller with the fragrance.

22. The production system according to claim 17, characterized in that the modular fragrance unit comprises a liquid bath, which provides the fragrance in liquid form.

23. The production system according to claim 17, characterized in that the modular fragrance unit comprises a spraying device, which is designed to spray the print substrate with the fragrance.

24. The production system according to claim 17, characterized in that the tank device comprises a magazine of a plurality of tank containers.

25. The production system according to claim 17, characterized in that the modular fragrance unit comprises a cleaning device.

26. A method for processing and/or finishing of a print substrate, in particular with a production system, preferably having a production system comprising a plurality of modular units according to claim 17,
characterized in that, after the print substrate has been printed by means of a modular printing unit, a fragrance is applied to the print substrate using a modular fragrance unit, wherein the modular fragrance unit comprises a tank device for storing the fragrance.

27. The method according to claim 26, characterized in that the fragrance is applied to the print substrate by the modular fragrance unit by means of a print head, preferably by means of a print head according to inkjet printing technology.

28. The method according to claim 26, characterized in that the fragrance is mixed into a preferably odor-free ink, wherein the ink is printed on the print substrate.

29. The method according to claim 26, characterized in that the modular fragrance unit comprises a separate printing unit, preferably a printing unit in accordance with offset printing technology, wherein the printing unit uses a moistening agent during operation, wherein the fragrance is mixed into the moistening agent.

30. The method according to claim 26, characterized in that the fragrance is applied to the print substrate by the modular fragrance unit by means of silk screen printing.

31. A modular fragrance unit for processing and/or finishing a print substrate, in particular for carrying out a method according to claim 26, comprising means for applying a fragrance to the print substrate.
